(19) United States
(12) Patent Application Publication
(10) Pub. No.: US 2018/0212956 A1
(43) Pub. Date: Jul. 26, 2018

(54) ANONYMOUS TOKEN AUTHENTICATION

(71) Applicant: CA, Inc., New York, NY (US)

(72) Inventor: Jayanth Sanganabhatla, Hyderabad (IN)

(21) Appl. No.: 15/414,431

(22) Filed: Jan. 24, 2017

(51) Int. Cl. H04L 29/06; G06F 17/30

(52) U.S. Cl. CPC H04L 63/0838; H04L 63/1433; G06F 17/30864; H04L 63/0428; H04L 63/0861

(57) ABSTRACT

When a user attempts to log in to his account from within an unsecure environment, such as a public computer or a third party application, the user is shown an anonymous token instead of a typical log in prompt to prevent the user from entering sensitive information. The anonymous token is random and is not associated with user data. The user opens a secure application associated with an authentication service to log in with appropriate credentials and provide the anonymous token. After authenticating the user, the authentication service temporarily associates user data with the anonymous token. An application within the unsecure environment, such as a browser, continuously listens for a user session associated with the anonymous token to be initiated. Once the browser detects a user session associated with the anonymous token, the browser retrieves the associated user data and automatically logs in the user.

### BACKGROUND

The disclosure generally relates to the field of information security, and more particularly to software development, installation, and management.

Webview is a simplified browser component found in mobile operating systems such as Apple's iOS and Google's Android. A webview browser lacks an address bar and has limited browser functionality hindering a user's ability to view the address of the page or a Secure Sockets Layer (SSL) certificate. Additionally, webview allows for JavaScript injection which can include scripts that communicate with a mobile application. With this JavaScript injection, a malicious application can inject a script to steal data entered in webview, such as a user's identity information or log in credentials. Publicly accessible computers suffer from a similar vulnerability. For example, a public computer may have keystroke logging software that captures input data.

### BRIEF DESCRIPTION OF THE DRAWINGS

Aspects of the disclosure may be better understood by referencing the accompanying drawings.

FIG. 1 depicts an example for system for authenticating a user using an anonymous token.

FIG. 2 depicts a flowchart with example operations for authenticating a user with an anonymous token.

FIG. 3 depicts a flowchart with example operations for authenticating a user with an anonymous token.

FIG. 4 depicts an example computer system with an anonymous token authenticator.

### DESCRIPTION

The description that follows includes example systems, methods, techniques, and program flows that embody aspects of the disclosure. However, it is understood that this disclosure may be practiced without these specific details. For instance, this disclosure refers to using an anonymous token to facilitate a log in process in illustrative examples. Aspects of this disclosure can also be applied to any instance where an unsecure environment may compromise input of sensitive information. In other instances, well-known instruction instances, protocols, structures and techniques have not been shown in detail in order not to obfuscate the description.

Introduction

When log ins from new or potentially unsecure environments are detected, some services employ more secure authentication techniques to prevent unauthorized access to a user's account. For example, two factor authentication may be used as an extra layer of security when verifying a user's identity. However, these techniques require a user to provide some identity information (e.g., a user name or mobile number) to retrieve a one time password (OTP). Requiring a user to enter sensitive information exposes the user to the risk of key logging software or malicious third party applications capturing the sensitive information. Additionally, some more secure authentication techniques, such as biometrics, require an initial set up process. For example, biometrics require a prior association of biometric data to a user's credentials. The initial set up process prevents these more secure authentication techniques from being used in a new, unknown environment.

Overview

When a user attempts to log in to his account from within an unsecure environment, such as a public computer or a third party application, the user is shown an anonymous token in place of a typical log in prompt to prevent the user from entering sensitive information. The anonymous token is not associated with user data and therefore cannot be used to access a user's account or ascertain information about the user. The user opens a secure application associated with an authentication service to log in with appropriate credentials and provide the anonymous token. After authenticating the user, the authentication service temporarily associates user data with the anonymous token. An application within the unsecure environment, such as a browser, continuously listens for a user session associated with the anonymous token to be initiated. Once the browser detects a user session associated with the anonymous token, the browser retrieves the associated user data and automatically logs in the user.

Terminology

The term “credential” as used throughout this description is any piece of information or pieces of information that can be used to identify a user or account within a system. Examples of a credential or credentials include an email address, a username and password, residential address, employee identifier, etc.

The term “account” and/or “user data” as used throughout this description refers to a set of user identity information or credentials. A user may establish an account by providing identity information and credentials to an authentication service that then maintains the information. For example, an account may be an entry in an authentication service's user store that includes a user ID, a password, and an email address for a particular user. If a user has an account with an environment, a user is considered to be known to that environment.

Example Illustrations

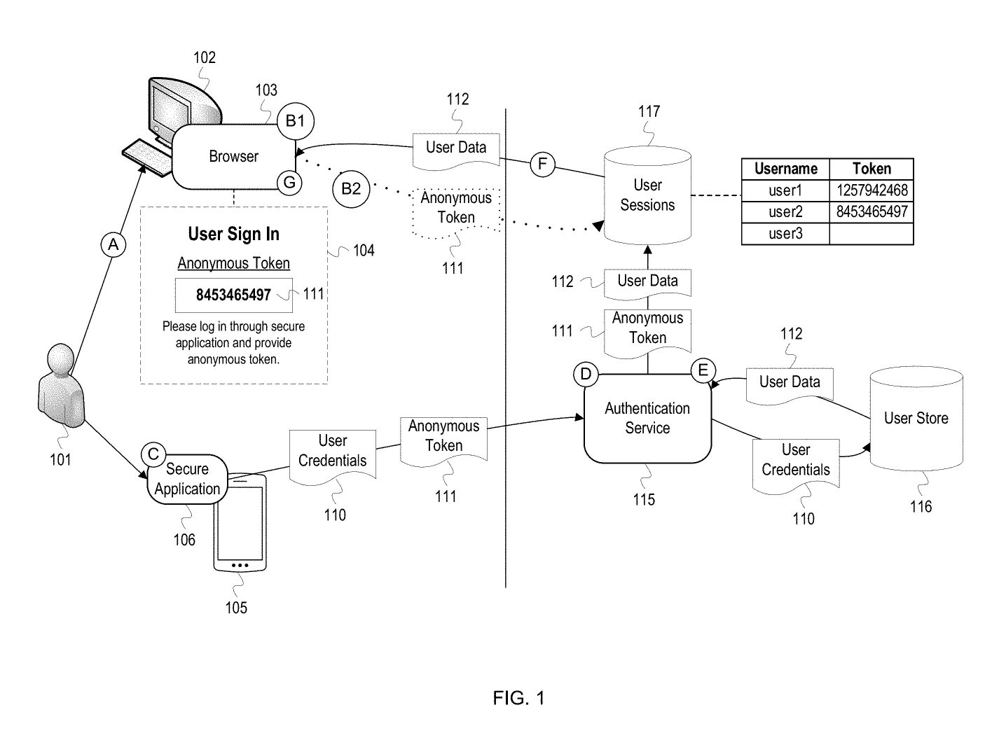

FIG. 1 depicts an example for system for authenticating a user using an anonymous token. FIG. 1 depicts an authentication service 115 that is communicatively coupled to a user store 116 and a user sessions database 117. FIG. 1 also depicts a public computer 102 that includes a browser 103 and a user device 105 that includes a secure application 106.

At stage A, a user 101 attempts to log in to a web page via the browser 103 on the public computer 102. The public computer 102 is a machine or computing device that is not owned by the user 101 and is therefore potentially unsecure. For example, the public computer 102 may have key logging software installed which could be used to ascertain sensitive information. The user 101 uses the browser 103 to navigate to the web page which includes privileged information and requires the user 101 to log in. For example, the web page may include sensitive financial information, health information, etc. The web page or the browser 103 include program code to determine that the public computer 102 is a potentially unsecure device based on a set of criteria. In some implementations, the criteria may include whether the public computer 102 is a known device (e.g. has previously been used to access the user's account). The web page may transmit an Internet Protocol (IP) address of the public computer 102 to the authentication service 115 to compare the IP address to previous user sessions. If the public computer 102 is unknown or is new to the user 101, the browser 103 determines that the public computer 102 is unsecure. Additionally, in some implementations, the criteria may include whether a Secure Hypertext Transfer Protocol (HTTPS) connection is being used. If a secure connection is not being used, the browser 103 determines that the public computer 102 or at least a web page being visited by the user 101 is unsecure. The browser 103 may also allow the user 101 to select a more secure authentication process through a user interface 104. For example, the user interface 104 may allow the user 101 to selectively log in with user credentials or log in using anonymous token authentication as described below.

At stage B1, in response to the browser 103 detecting that the public computer 102 is potentially unsecure, the browser 103 displays an anonymous token 111 in the user interface 104. Since the public computer 102 is potentially unsecure, the anonymous token 111 is displayed in place of a normal log in prompt so that the user 101 does not input sensitive information which might be ascertained by the public computer 102. In some implementations, the browser 103 may deactivate the text fields for entering credentials. The user interface 104 also instructs the user 101 to log in through the secure application 106 and provide the anonymous token 111. In FIG. 1, the anonymous token 111 is a random number but may also be a random alphanumeric string or words, may be of varying length, include special characters, etc. The anonymous token 111 is not based on data for the user 101 and is therefore considered anonymous since the anonymous token 111 cannot be used to ascertain user data. The browser 103 requests the anonymous token 111 from the authentication service 115 who generates and returns the anonymous token 111. The authentication service 115 may encrypt the anonymous token 111 or validate the browser 103 prior to providing the anonymous token 111. For example, the authentication service 115 may track a number of tokens requested by the browser 103 within a time period and not provide another token if the number of requests exceeds a threshold. In some implementations, the anonymous token 111 may be generated locally within the browser 103; however, additional security precautions may be necessary to prevent alteration to a token generation script that executes within the browser 103.

At stage B2, the browser 103 begins listening to the user sessions database 117 for a user session associated with the anonymous token 111. Because the browser 103 does not have identity information for the user 101, the browser 103 uses the anonymous token 111 to determine whether a user session associated with the anonymous token 111 has been initiated. The browser 103 is described as “listening” to or monitoring the user sessions database 117 because the browser 103 is checking for changes to the user sessions database 117 over a period of time. The browser 103 may listen for changes by periodically submitting a query with the anonymous token 111 to the user sessions database 117 and determining whether the query returned a result. The browser 103 may submit the queries using various protocols such as Asyncronous JavaScript and XML (AJAX) and Representational State Transfer (REST). The browser 103 may also use an application programming interface (API) of the authentication service 115 to query the user sessions database 117. Additionally, the browser 103 may trigger a script to be executed by the user sessions database 117 or the authentication service 115 to continually check for a user session associated with the anonymous token 111 and to return user data if such a user session is detected. In some implementations, the anonymous token 111 has an expiration time (e.g. 5 minutes), so the browser 103 listens for user sessions associated with the anonymous token 111 until the anonymous token 111 expires.

At stage C, the user 101 enters user credentials 110 and the anonymous token 111 through the secure application 106 executing on the user device 105. The user device 105 is a device that is owned by or known to the user 101, such as a mobile device, laptop, personal desktop, etc. The secure application 106 is an application that is supplied by a trusted source and is known to be secure. For example, the secure application 106 may be provided by a bank with whom the user 101 has established an account. Additionally, the secure application 106 may be associated with an open authentication account which is used to access multiple websites or services. The user credentials 110 are credentials that the user 101 has previously established with the authentication service 115. The user 101 may input the user credentials 110 or perform biometric authentication in instances where the user 101 previously associated biometric data with the user credentials 110. The user 101 also inputs the anonymous token 111 into the secure application 106. The secure application 106 forwards the user credentials 110 and the anonymous token 111 to the authentication service 115.

At stage D, the authentication service 115 authenticates the user 101 based on the user credentials 110 and retrieves user data 112 from the user store 116. The authentication service 115 may use various authentication schemes, such as the Initiative for Open Authentication (OAUTH), OpenID, a Kerberos authentication scheme, Java Authentication and Authorization Service (JAAS), etc. In general, if the user credentials 110 match credentials stored in the user store 116, the authentication service 115 determines that the user 101 is authentic. The authentication service 115 retrieves the user data 112 associated with an account for the user 101. The user data 112 is data that may be used to identify the user 101 to a service or web page, such as a username or email address.

At stage E, the authentication service 115 associates the anonymous token 111 with the user data 112 in the user sessions database 117. Because the user credentials 110 were successfully authenticated, the authentication service 115 initiates a session for the user 101 in the user sessions database 117 by creating an entry with the user data 112. Having an active session in the user sessions database 117 indicates that the user 101 is allowed to access protected resources. Additionally, because the anonymous token 111 was provided with the user credentials 110, the authentication service 115 includes the anonymous token 111 in a field associated with the user session entry for the user 101. In FIG. 1, the example data for the user sessions database 117 depicts the anonymous token 111 being associated with a username of “user2,” which was indicated in the user data 112. The user sessions database 117 does not require that a user session be associated with a token. For example, a user which logs in from a secure device or through a secure web page may not use an anonymous token.

At stage F, the browser 103 retrieves the user data 112 from the user sessions 117 based on the user data 112 being associated with the anonymous token 111. The user data 112 is supplied in response to the browser 103 initiated listening at stage B2. For example, once the anonymous token 111 is associated with the user data 112, the browser's 103 query using the anonymous token 111 returns a result indicating the user data 112. In some implementations, instead of supplying the user data 112, the authentication service 115 may provide an authenticated token or key that can be used by the browser 103 to access protected resources.

At stage G, the browser 103 forwards the user 101 to a landing page for authenticated users. Because a user session associated with the anonymous token 111 was initiated, the browser 103 determines that the user 101 has been authenticated and provides the protected resource requested by the user 101 at stage A. The browser 103 may automatically forward the user 101 to a requested resource without further action from the user 101. Additionally, using the user data 112, the browser 103 can forward the user 101 to a web page or service specific to the user 101.

After receiving the user data 112, the browser may also transmit a message to clear the anonymous token 111 from the user sessions database 117. The association between the anonymous token 111 and the user data 112 can be temporary, so the anonymous token 111 may be cleared from the user sessions database 117. This maintains the anonymity of the anonymous token 111 and prevents any permanent association between the user data 112 and the anonymous token 111 which might be exploited by a malicious party. The browser 103 may submit a query, use an API of the authentication service 115 or the user sessions database 117, etc., to clear the anonymous token 111.

FIG. 1 describes the user 101 as attempting to log in to a service via the browser 103 on the public computer 102. In some instances, the operations described in FIG. 1 may be performed in response to the user 101 attempting to log in through a potentially unsecure application, whether the application resides on a known or public device. A potentially unsecure application may be an application from a third party or an application that uses webview for an authentication process. A web page may be programmed to detect when the user 101 is attempting to log in through webview or a third party application and display an anonymous token as described above in place of a normal authentication process. For example, in the context of FIG. 1, the user 101 may attempt to log in through an unsecure application on the user device 105. After detecting that the application is unsecure, an anonymous token would be displayed to the user 101. The user 101 may then close the unsecure application and open the secure application 106 to enter the anonymous token and user credentials. The user 101 can then reopen the unsecure application and be automatically logged in.

FIG. 1 is annotated with a series of letters A-G. These letters represent stages of operations. Although these stages are ordered for this example, the stages illustrate one example to aid in understanding this disclosure and should not be used to limit the claims. Subject matter falling within the scope of the claims can vary with respect to the order and some of the operations.

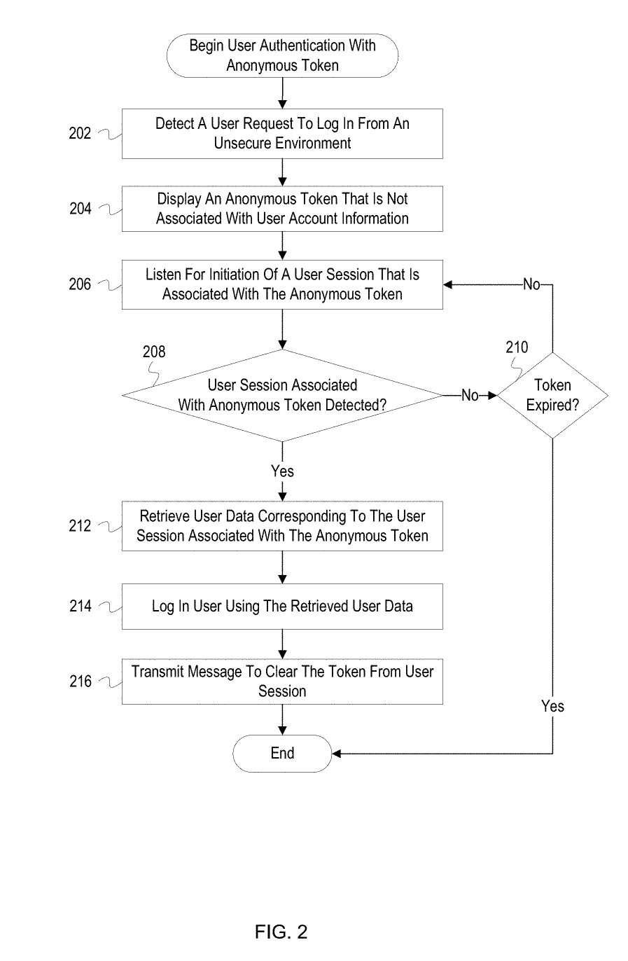

FIG. 2 depicts a flowchart with example operations for authenticating a user with an anonymous token. The operations of FIG. 2 are described as being performed by a browser for ease of explanation, though names of program code may vary among different implementations.

A browser detects a user request to log in from an unsecure environment (202). The browser may detect that the user clicked a link to request a log in prompt or that the user was forwarded to a log in page from another service or web page. The browser determines that one or more criteria indicate that the user is requesting to log in from an unsecure environment. An unsecure environment may be a public computer, an unknown application, or an unsecure/unencrypted web page. The criteria may include whether the user has previously logged in from within the environment, how long since the user last logged in, whether a secure/encrypted protocol is being used, whether webview is being used, a location of a device being used to log in, an IP address of the device, a media access control (MAC) address of the device, a type of operating system, a type of browser, a time of day, or any combination of the foregoing. The browser may assign weights to the different conditions. For example, even if the user is logging in from a known device, the browser may still determine that the environment is unsecure based on the user logging in from an unknown location at an unusual time of day. In some instances, the user may request, via clicking a link or an option in a menu, that a more secure log in process be used. In such instances, the browser determines that the user is logging in from an unsecure environment.

The browser displays an anonymous token (204). Because the user is operating within an unsecure environment, the browser does not allow the user to enter credentials, such as a username, password, email address, phone number, etc. The browser may deactivate text fields for sensitive information within a web page or display a prompt warning that the user should not enter information because of the unsecure environment. Additionally, the browser requests that a backend (i.e. server side) application generate and supply an anonymous token. The browser displays the anonymous token and instructs the user to log in through a secure application and provide the anonymous token. The token is unrelated to any user data and may consist of random alphanumeric characters, may vary in length, may consist of random words, etc. In some implementations, the token may be a picture that the user describes when logging in through a secure application. For example, the browser may display a picture of a boat, and the user may enter “boat” as the token when logging in.

The browser listens for initiation of a user session that is associated with the anonymous token (206). The browser communicates with the backend authentication service that manages user authentication and user sessions. The browser may query a user session database using the anonymous token, pass the anonymous token to the authentication service through an API or REST protocol, etc.

The browser determines whether a user session associated with the anonymous token has been detected (208). The browser may determine whether any user data was received in response to its queries, whether the authentication service returned user data, etc.

If the browser has not detected a user session associated with the anonymous token, the browser determines whether the anonymous token has expired (210). If the anonymous token has expired, the process ends. The browser quits listening for a user session associated with the anonymous token. The browser may also transmit a message indicating to the authentication service that the token has expired. In response to detection of another log in request, the browser may generate and display a new anonymous token to be entered by the user. If the anonymous token has not expired, the browser continues listening for a user session associated with the anonymous token (206).

If the browser has detected a user session associated with the anonymous token (208), the browser retrieves user data corresponding to the user session associated with the anonymous token (212). The user data is data that may be used to identify a user such as an email address or a user name. The browser may also retrieve other data using the user data such as a user's financial information, account information, or any other protected data which the user has requested.

The browser logs in the user using the retrieved user data (214). For example, the browser may log in the user by loading a landing page or other requested page for which authentication was required. The browser may also display any additional data retrieved using the user's data. In instances where a third party application forwarded the user to the log in prompt, the browser may pass the user data back to the third party application or otherwise indicate that the user has been successfully authenticated.

The browser transmits a message to clear the token from the user session (216). To enhance security, any record that may link the anonymous token to the user data can be cleared from the browser and the authentication service. For example, if the anonymous token is stored in an entry for the user in a user sessions database, the browser may submit a query or otherwise request that the anonymous token be deleted from the database. Locally, the browser may also ensure that the anonymous token has not been cached and has been cleared from memory.

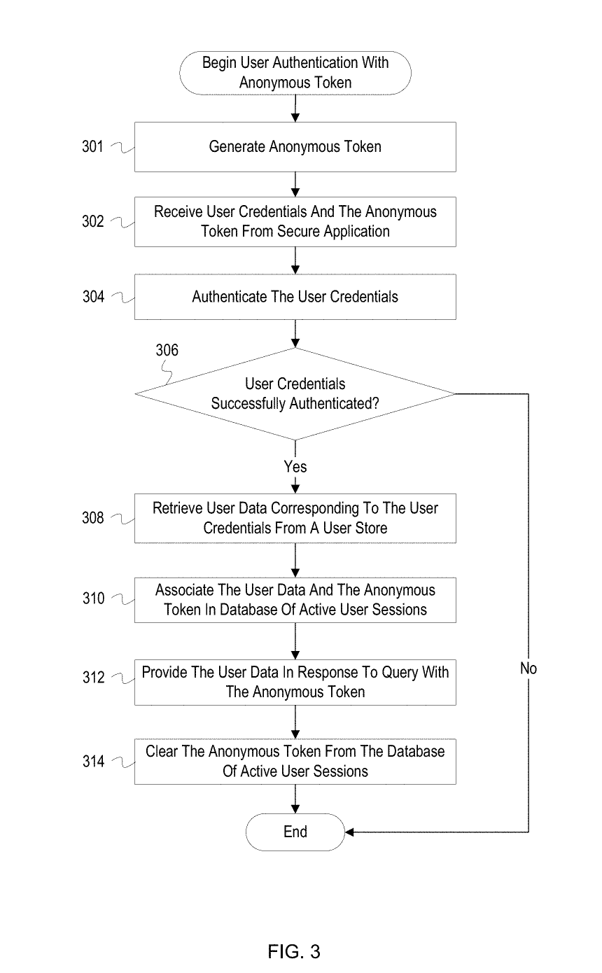

FIG. 3 depicts a flowchart with example operations for authenticating a user with an anonymous token. The operations of FIG. 3 are described as being performed by an authentication service for ease of explanation, though names of program code may vary among different implementations.

An authentication service (“service”) generates an anonymous token (301). The service receives a request from a browser or application that is attempting to authenticate a user using an anonymous token. The request may be received using various communication protocols, such as HTTP, HTTPs, REST, etc. The service randomly generates and provides the anonymous token in response to the request. If the browser or application has been preconfigured with a shared key, the service may encrypt the anonymous token prior to supplying the token.

The service receives user credentials and the anonymous token from a secure application (302). The secure application may be an application provided by an owner of the service, an application executing on a device known to be associated with a user, an application which has a shared encryption key with the authentication service or is otherwise known to the authentication service, an application that uses a secure communication protocol, etc. The secure application may execute on a mobile device, a desktop computer, laptop, within a browser, etc.

The service authenticates the user credentials (304). The service may use various authentication schemes to authenticate the user credentials. The service may first determine whether an account associated with the user exists and then determine whether the provided credentials are associated with the user's account. In some implementations, the service may use a single sign on (SSO) authentication scheme and receive an already authenticated SSO token or other type of credential.

The service determines whether the user credentials were successfully authenticated (306). If the user credentials were not successfully authenticated, the process ends. The service may transmit an error message or otherwise indicate to the secure application that the credentials were not successfully authenticated.

If the user credentials were successfully authenticated, the service retrieves user data corresponding to the user credentials from a user store (308). The user data comprises data that may be used to identify the user to a web page or application that is requesting authentication of the user. For example, the user data may be an account number, username, email address, etc.

The service associates the user data and the anonymous token in a database of active user sessions (310). The service creates an entry in the user sessions database indicating that there is an active session for the user. The user sessions database includes a field for anonymous tokens. Since an anonymous token was provided with the user credentials, the service stores the anonymous token along with the user data in the entry for the user. In some implementations, the active user sessions may be maintained in a table in memory or storage as opposed to a database. In some implementations, the service maintains associations between user data and anonymous tokens in an encrypted table in memory. The service maintains the associations separately from the user sessions database and encrypts the associations so that no plain text association of the anonymous token and the user data exists. The service may select a single piece of unique user data such as a user name and map it to the anonymous token. The service then encrypts the mapping using a key or hash and stores the mapping in memory.

The service provides the user data in response to a query with the anonymous token (312). The service receives queries or API calls from a browser or application that is attempting to determine whether a user session associated with the anonymous token has been initiated. Once there is a user session associated with the anonymous token, the service provides the user data associated with the anonymous token in response to the query. The service may provide some or all of the user data based on which data has been requested, the source of the request, etc. In implementations where the associations between anonymous tokens and user data are encrypted, the service may temporarily decrypt the associations, or the service may hash the anonymous token and determine whether the hashed token matches any existing hashed tokens stored in the associations.

The service clears the anonymous token from the database of active user sessions (314). The service may clear the anonymous token immediately after supplying the user data or after a request to clear the token has been received from a browser or application requesting authentication of the user. The service deletes the token to ensure that an association between the user data and the anonymous token no longer exists.

Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 214 and 216 of FIG. 2 can be performed in parallel or concurrently. Additionally, the operation depicted in block 316 of FIG. 3 may not be performed. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

The description above describes using an anonymous token during a log in process for a user. Similar operations may be applied each time sensitive data may be entered by a user into a potentially unsecure environment. For example, a user using a publicly accessible device to check in at a doctor's office may be requested to provide a social security number and sensitive health information. The public terminal can display an anonymous token instead of requesting that the user enter the sensitive information. The user can then enter the anonymous token and the sensitive information into a secure application supplied by the healthcare provider on his/her personal device. A secure backend service could then process the provided information and transmit a message to the public device to display additional information to the user.

In some implementations, an authentication service may encrypt an anonymous token prior to associating the token with user data. The service encrypts the anonymous token using a key or hash that may be shared with a browser or application requesting authentication of the user. The browser then supplies an encrypted or hashed version of the authentication token to retrieve the user data associated with the anonymous token.

The variations described above do not encompass all possible variations, implementations, or embodiments of the present disclosure. Other variations, modifications, additions, and improvements are possible.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

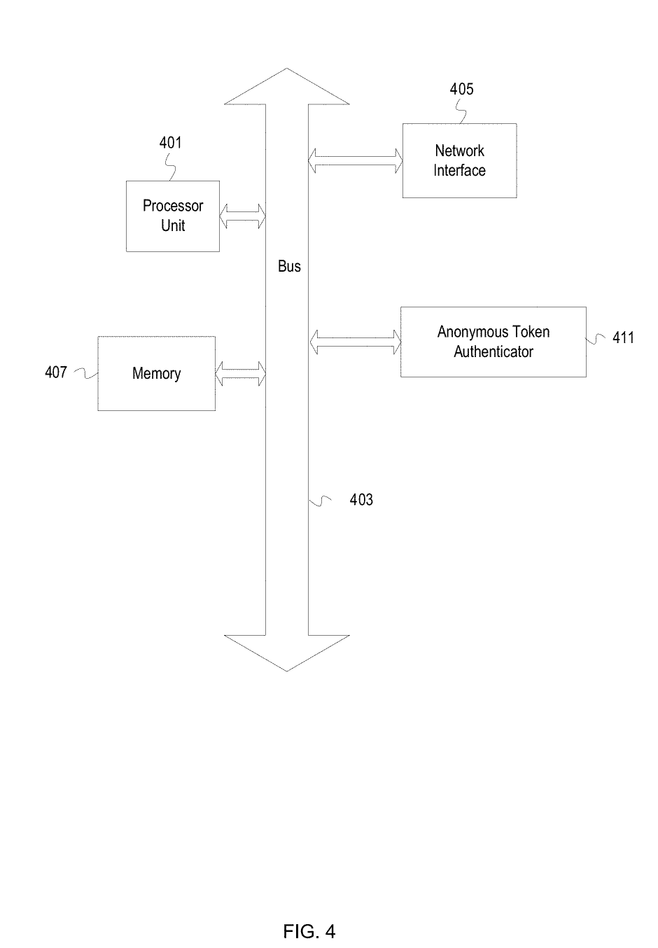

FIG. 4 depicts an example computer system with an anonymous token authenticator. The computer system includes a processor unit 401 (possibly including multiple processors, multiple cores, multiple nodes, and/or implementing multi-threading, etc.). The computer system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., PCI, ISA, PCI-Express, HyperTransport® bus, InfiniBand® bus, NuBus, etc.) and a network interface 405 (e.g., a Fiber Channel interface, an Ethernet interface, an internet small computer system interface, SONET interface, wireless interface, etc.). The system also includes an anonymous token authenticator 411. The anonymous token authenticator 411 generates an anonymous token and listens for the token to be associated with a user session. Once a user session associated with the token is detected, the anonymous token authenticator 411 retrieves the associated user's data and logs in the user. Any one of the previously described functionalities may be partially (or entirely) implemented in hardware and/or on the processor unit 401. For example, the functionality may be implemented with an application specific integrated circuit, in logic implemented in the processor unit 401, in a co-processor on a peripheral device or card, etc. Further, realizations may include fewer or additional components not illustrated in FIG. 4 (e.g., video cards, audio cards, additional network interfaces, peripheral devices, etc.). The processor unit 401 and the network interface 405 are coupled to the bus 403. Although illustrated as being coupled to the bus 403, the memory 407 may be coupled to the processor unit 401.

While the aspects of the disclosure are described with reference to various implementations and exploitations, it will be understood that these aspects are illustrative and that the scope of the claims is not limited to them. In general, techniques for providing authentication using an anonymous token as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Use of the phrase “at least one” of preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

What is claimed is:

1. A method comprising:
based on detecting a login attempt from within a first environment, preventing input of login credentials;
obtaining an anonymous token; and
displaying the anonymous token in the first environment;
monitoring a plurality of user sessions maintained by an authentication service; and
based on detecting that the anonymous token has been associated with a first user session of the plurality of user sessions,
retrieving user data indicated in the first user session; and
completing the login attempt based, at least in part, on the user data.

2. The method of claim 1 further comprising:
determining that one or more of a set of criteria indicate that the first environment is unsecure;
wherein preventing input of login credentials, obtaining the anonymous token, and displaying the anonymous token are also based on determining that one or more of the set of criteria indicate that the first environment is unsecure.

3. The method of claim 2, wherein the set of criteria comprises at least one of whether a previous login originated within the first environment, whether the first environment uses an encrypted communication protocol, and whether the first environment uses a browser indicated as unsecure.

4. The method of claim 1 further comprising instructing the authentication service to disassociate the anonymous token from the first user session.

5. The method of claim 1, wherein obtaining the anonymous token comprises requesting that the authentication service generate the anonymous token, wherein the anonymous token is a randomly generated sequence of characters and is not associated with a user account or related to user data.

6. The method of claim 1, wherein monitoring the plurality of user sessions maintained by the authentication service comprises:
periodically querying a database of the plurality of user sessions using the anonymous token;
wherein detecting that the anonymous token has been associated with the first user session comprises receiving an indication of the first user session in response to the querying.

7. The method of claim 1, wherein the authentication service receives login credentials and the anonymous token from a second environment indicated as secure, wherein the authentication service associates the anonymous token with the first user session based, at least in part, on successful authentication of the login credentials.

8. The method of claim 1 further comprising:
determining that the anonymous token has expired; and
based on determining that the anonymous token has expired, stopping monitoring the plurality of user sessions.

9. The method of claim 1 further comprising:
determining that one or more of a set of criteria indicate that the first environment is secure; and
based on determining that one or more of the set of criteria indicate that the first environment is secure, displaying a login prompt for credentials to be entered.

10. One or more non-transitory machine-readable media comprising program code for performing authentication using an anonymous token, the program code to:
based on successful authentication of received login credentials and receipt of an anonymous token,
retrieve user data associated with the login credentials;
associate the anonymous token with a first user session which includes the user data; and
based on receipt of a request to identify a user session associated with the anonymous token,
supply the user data; and
disassociate the anonymous token from the first user session.

11. The machine-readable media of claim 10, further comprising program code to:
receive data about a web interface from which a login attempt is being performed;
determine that the data indicates that web interface is unsecure;
generate the anonymous token, wherein the anonymous token is a randomly generated sequence of characters; and
supply the anonymous token to the web interface;
wherein the login credentials and the anonymous token are received from a secure application.

12. An apparatus comprising:
a processor; and
a machine-readable medium having program code executable by the processor to cause the apparatus to,
based on detection of a login attempt from within a first environment, prevent input of login credentials;
obtain an anonymous token; and
display the anonymous token in the first environment;
monitor a plurality of user sessions maintained by an authentication service; and
based on a determination that the anonymous token has been associated with a first user session of the plurality of user sessions,
retrieve user data indicated in the first user session; and
complete the login attempt based, at least in part, on the user data.

13. The apparatus of claim 12 further comprising:
determine that one or more of a set of criteria indicate that the first environment is unsecure;
wherein the program code executable by the processor to cause the apparatus to prevent input of login credentials, obtain the anonymous token, and display the anonymous token are also based on a determination that one or more of the set of criteria indicate that the first environment is unsecure.

14. The apparatus of claim 13, wherein the set of criteria comprises at least one of whether a previous login originated within the first environment, whether the first environment uses an encrypted communication protocol, and whether the first environment uses a browser indicated as unsecure.

15. The apparatus of claim 12 further comprising program code executable by the processor to cause the apparatus to instruct the authentication service to disassociate the anonymous token from the first user session.

16. The apparatus of claim 12, wherein the program code executable by the processor to cause the apparatus to obtain the anonymous token comprises program code executable by the processor to cause the apparatus to request that the authentication service generate the anonymous token, wherein the anonymous token is a randomly generated sequence of characters and is not associated with a user account or related to user data.

17. The apparatus of claim 12, wherein the program code executable by the processor to cause the apparatus to monitor the plurality of user sessions maintained by the authentication service comprises program code executable by the processor to cause the apparatus to:
periodically query a database of the plurality of user sessions using the anonymous token;
wherein the program code executable by the processor to cause the apparatus to detect that the anonymous token has been associated with the first user session comprises program code executable by the processor to cause the apparatus to receive an indication of the first user session in response to the querying.

18. The apparatus of claim 12, wherein the authentication service receives login credentials and the anonymous token from a second environment indicated as secure, wherein the authentication service associates the anonymous token with the first user session based, at least in part, on successful authentication of the login credentials.

19. The apparatus of claim 12 further comprising program code executable by the processor to cause the apparatus to:
determine that the anonymous token has expired; and
based on a determination that the anonymous token has expired, stop monitoring the plurality of user sessions.

20. The apparatus of claim 12 further comprising program code executable by the processor to cause the apparatus to:
determine that one or more of a set of criteria indicate that the first environment is secure; and
based on a determination that one or more of the set of criteria indicate that the first environment is secure, display a login prompt for credentials to be entered.
